(19) United States
(12) Patent Application Publication
(10) Pub. No.: US 2023/0404046 A1
(43) Pub. Date: Dec. 21, 2023

(54) AQUACULTURE TANK SYSTEM

(71) Applicant: Only Alpha Pool Products, LLC, Fort Wayne, IN (US)

(72) Inventor: Timothy M. Saxer, Angola, IN (US)

(73) Assignee: Only Alpha Pool Products, LLC, Fort Wayne, IN (US)

(21) Appl. No.: 18/338,019

(22) Filed: Jun. 20, 2023

Related U.S. Application Data
(60) Provisional application No. 63/353,755, filed on Jun. 20, 2022.

(51) Int. Cl. A01K 63/00

(52) U.S. Cl. CPC A01K 63/006

(57) ABSTRACT

An aquaculture tank system includes: an aquaculture tank configured for holding a liquid and at least one first animal therein; and a cover coupled with the aquaculture tank for covering the liquid, the cover including a sheet-like central portion with a plurality of openings, at least some of the openings being sized and configured for providing a dual functionality of: (a) allowing an animal feed to pass therethrough in order to feed the at least one first animal in the aquaculture tank; and (b) preventing at least one second animal located exterior to the aquaculture tank from removing the at least one first animal from the aquaculture tank.

### BACKGROUND OF THE INVENTION

### 1. Field of the Invention

The present invention relates to aquaculture devices, and, more particularly, to aquaculture tank systems.

### 2. Description of the Related Art

Aquaculture provides for controlled cultivation of aquatic organisms, including plants and animals. Such animals include, but are not limited to, fish, mollusks (i.e., clams, mussels), and crustaceans (i.e., shrimp, lobsters, crabs). Aquaculture can be provided, for example, offshore, inshore, or onshore, and can include tanks for providing at least a partially enclosed environment for the cultivation. A problem with aquaculture tanks onshore, for example, concerns the need to be able to feed the animals in the tanks, which can provide an open environment to predators, such as birds of prey, which can snag the animals in the tank and eat them.

What is needed in the art is a way to be able to feed animals in an aquaculture tank, while at the same time protecting the animals from predators.

### SUMMARY OF THE INVENTION

The present invention provides an aquaculture tank system including a tank and a cover, the cover including openings which allow for feeding of the animals in the tank and which protect the animals from predators.

The invention in one form is directed to an aquaculture tank system, including: an aquaculture tank configured for holding a liquid and at least one first animal therein; and a cover coupled with the aquaculture tank for covering the liquid, the cover including a sheet-like central portion with a plurality of openings, at least some of the openings being sized and configured for providing a dual functionality of: (a) allowing an animal feed to pass therethrough in order to feed the at least one first animal in the aquaculture tank; and (b) preventing at least one second animal located exterior to the aquaculture tank from removing the at least one first animal from the aquaculture tank.

The invention in another form is directed to a cover for use with an aquaculture tank having an upper perimeter with at least one bead slot, the cover including: a sheet-like central portion with a plurality of openings, at least some of the openings being sized and configured for providing a dual functionality of: (a) allowing an animal feed to pass therethrough in order to feed the at least one first animal in the aquaculture tank; and (b) preventing at least one second animal located exterior to the aquaculture tank from removing the at least one first animal from the aquaculture tank; and a perimeter bead body coupled with the central portion and configured for being received within the at least one bead slot.

The invention in yet another form is directed to a method of using an aquaculture tank system, the method including the steps of: providing that the aquaculture tank system includes an aquaculture tank and a cover, the aquaculture tank being configured for holding a liquid and at least one first animal therein; and coupling the cover with the aquaculture tank for covering the liquid, the cover including a sheet-like central portion with a plurality of openings, at least some of the openings being sized and configured for providing a dual functionality of: (a) allowing an animal feed to pass therethrough in order to feed the at least one first animal in the aquaculture tank; and (b) preventing at least one second animal located exterior to the aquaculture tank from removing the at least one first animal from the aquaculture tank.

An advantage of the present invention is that it provides a cover with dual functionality of allowing for feeding of and protecting of the animals in the tank.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of an aquaculture tank system including an aquaculture tank holding a liquid therein and a cover, according to an exemplary embodiment of the present invention;

FIG. 2 is top perspective view of the cover of FIG. 1, according to an exemplary embodiment of the present invention;

FIG. 3 is a side, cross-sectional view of the aquaculture tank system, taken along line 3-3 in FIG. 2, with portions broken away, according to an exemplary embodiment of the present invention;

FIG. 4 is a side, cross-sectional view of another embodiment of the aquaculture tank system of the present invention, with portions broken away, according to an exemplary embodiment of the present invention;

FIG. 5 is a perspective view of another embodiment of the aquaculture tank system of the present invention, the aquaculture tank system including an aquaculture tank and a cover, according to an exemplary embodiment of the present invention;

FIG. 6 is a perspective view of the cover of FIG. 5, according to an exemplary embodiment of the present invention;

FIG. 7 is a perspective view of the cover of FIG. 5, according to an exemplary embodiment of the present invention;

FIG. 8 is a side, cross-sectional view of yet another embodiment of the aquaculture tank system of the present invention, with portions broken away, according to an exemplary embodiment of the present invention; and

FIG. 9 is a flow diagram showing a method of using an aquaculture tank system, in accordance with an exemplary embodiment of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

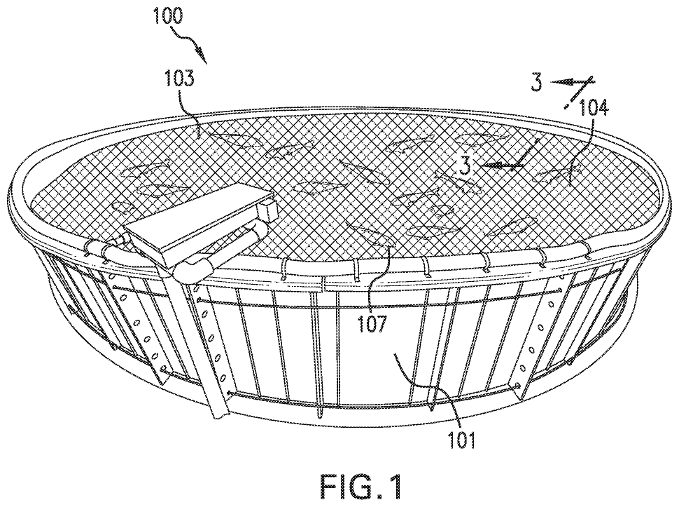

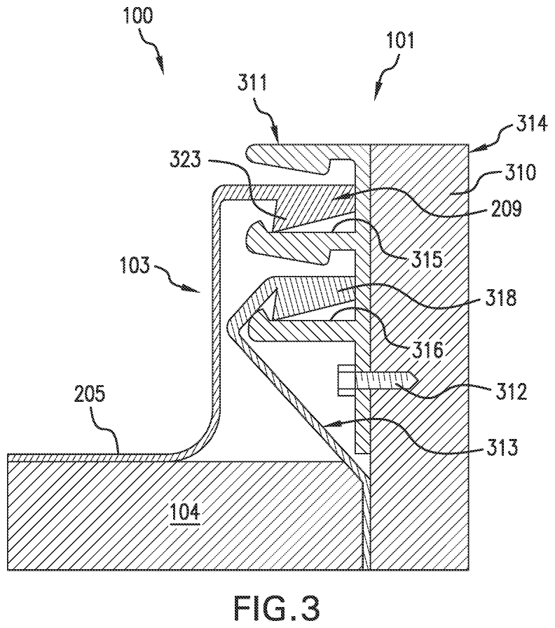

Referring now to the drawings, and more particularly to FIG. 1, there is shown an aquaculture tank system 100, which generally includes an aquaculture tank 101, pipes (not fully shown), and a cover 103 for use with tank 101. Tank 101 is configured for holding a liquid 104 and at least one animal 107 in liquid 104 (which can be, for example, water). Animal 107 can be any animal, including but not limited to fish, mollusks (i.e., clams, mussels), and crustaceans (i.e., shrimp, lobsters, crabs). Tank 101 can have any suitable configuration, such as but not limited to a circular configuration as shown in FIG. 1. Tank 101 can be made of any suitable material(s)(such as any non-toxic material) and in any suitable manner, such as a tank including a plurality of composite wall panels (FIG. 3) joined in edge-to-edge fashion. Exemplary constructions are described in U.S. Pat. Nos. 8,505,247 and 8,215,069, which are incorporated by reference herein in their entirety. The pipes (which can include conduits and/or other communication lines) can be positioned in, on, around, and/or otherwise attached to tank 101 and can serve to convey liquid 104 and/or other substances into or out of tank 101, as well as to convey waste or contaminants out of tank 101. Cover 103 is shown schematically in FIG. 1 and generally serves to cover a top portion of liquid 104 in tank 101. Cover 103 is coupled with tank 101 (as described more fully below). As shown in FIG. 1, cover 103 can, according to one example, have a grid-like configuration.

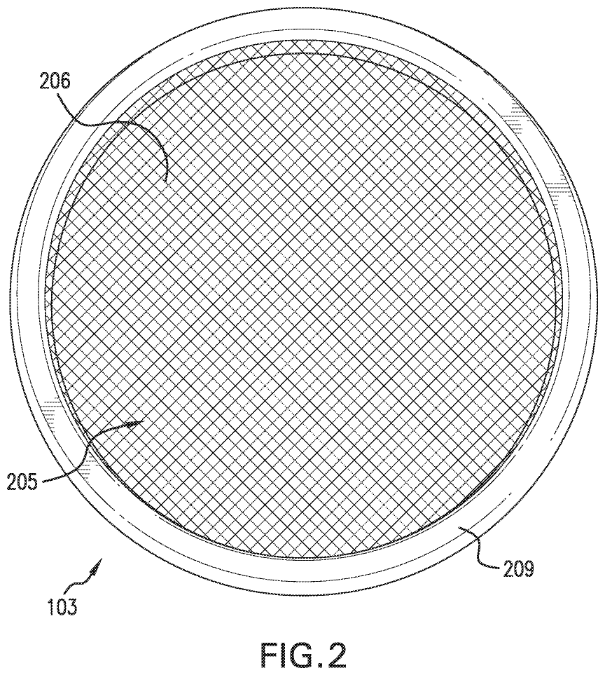

Referring now to FIG. 2, there is shown a top perspective view of cover 103. Cover 103 includes a sheet-like central portion 205 (which can be referred to as netting 205 or mesh 205) with a plurality of openings 206 (which can also be referred to as holes 206). At least some of openings 206 are sized and configured for providing a functionality of: (a) allowing water and an animal feed provided by an operator (such as a grower) to pass therethrough in order to feed the at least one animal 107 in the aquaculture tank 101, without removing cover 103; (b) preventing at least one second animal located exterior to aquaculture tank 101 from removing the at least one first animal 107 from aquaculture tank 101; and (c) keeping animal 107 in tank 101 and thus from exiting tank 101 (such as a fish from jumping out of tank 101). Netting 205 can be made of any suitable material, have any suitable design, and be made in any suitable manner. For example, netting 205 can be lightweight and flexible. Netting 205 can be, for example, made from non-toxic, ultraviolet (UV) stabilized polyethylene with a load factor of 8.5 lbs/1000 sq/ft. (pound mass per square foot (PMSF))(as an alternative example, netting 205 can be made of polypropylene). Further, by way of example and not limitation, netting 205 can have ½ inch or ¾ inch square openings 206. However, the size of openings 206 depends at least upon the particular classification of animal 107 (such as genus and species, for example a particular species of fish). Further, the shape of openings 206 need not be square, but can be any suitable shape, such as circular, triangular, rectangular, etc. Further, cover 103 further includes a perimeter, which forms an outer perimeter of cover 103. This perimeter includes an outer perimeter portion of netting 205 and a perimeter bead body 209. Perimeter bead body 209 can be made of any suitable material, such as a metal for example, steel, aluminum), a polymer or plastic, and/or carbon steel, and can be made in any suitable manner. Perimeter bead body 209 is continuous about the perimeter of covering 103, as shown in FIG. 2, and can be a continuous extrusion. FIG. 2 can be understood to be schematically showing a coupling between netting 205 and perimeter bead body 209, this coupling being explained in various embodiments of the present invention, below. This is assumed to be the case herein. Even so, it can be understood that FIG. 2 shows netting 205 coupled with perimeter bead body 209 by way of netting 205 being integrally formed with perimeter bead body 209, such as by way of a molding operation, wherein netting 205 is molded with and thereby encapsulated by a material (such as a polymer or plastic) of perimeter bead body 209.

Referring now to FIG. 3, there is shown schematically a cross-sectional view, with portions broken away, of aquaculture tank system 100 taken along line 3-3 in FIG. 1. System 100 is shown to include tank 101, cover 103, and a tank liner 313 (which can be made of any suitable material, such as vinyl or polyethylene), and liquid 104 is in tank 101 and covered by cover 103 (a coupling of netting 205 and perimeter bead body 209 is shown schematically in FIG. 3 and thus without detail). Tank 101 includes a wall panel 310 and a coupling mechanism 311. Tank 101 can include a plurality of wall panels 310 joined to one another, and a plurality of coupling mechanisms 311 attached respectively to a wall panel 310. Coupling mechanism 311 can be formed integral with a respective wall panel 310 or can be coupled with a respective wall panel 310 in any suitable manner, such as by way of fasteners 312 (which form part of tank 101), such as a screw or bolt. Coupling mechanism 311 is coupled with an upper portion of wall panel 310. Stated otherwise, wall panels 310 together include an upper perimeter 314 which includes the upper portion of each wall panel 310 and coupling mechanism 311 coupled therewith. Coupling mechanism 311 includes a first (upper) bead slot 315 and a second (lower) bead slot 316 (such that coupling 311 can be referred to as an F-track coping, a double F-track coping, or a double track, given the two slots 315, 316), each slot 315, 316 extending at least substantially around upper perimeter 314 of wall panels 310. That is, each slot 315, 316 of each coupling mechanism 311 attached to each wall panel 310 can form substantially continuous respective slots 315, 316 at least substantially all the way around upper perimeter 314. Coupling mechanism 311 can be made of any suitable material, such as a metal (for example, steel, aluminum), a polymer or plastic, and/or carbon steel. Further, coupling mechanism 311 can be made in any suitable manner. For example, coupling mechanism 311 with its slots 315, 316 can be an aluminum extrusion. Perimeter bead body 209 includes bead 323 (shown to include a ledge or lip), bead body 209 being received in, and held in (by way of bead 323 and a lip of slot 315), bead slot 315, and can be removed from bead slot 315. In this way bead 323 is selectively received in and removed from slot 315, such that bead body 209 is removably received in slot 315. Liner 313 is flexible and configured for lining an inside surface of tank 101 so as to facilitate in containing liquid 104. Further, liner 313 includes a perimeter including a bead body 318, which is removably received within lower bead slot 316. Bead body 318 can be held in slot 316 by a lip of slot 316. Liner 313 can be made of any suitable material and in any suitable manner. For example, all materials of liner 313 can be unharmful with respect to any animals that will be in tank 101. Bead body 318 can be made of any suitable material, such as a metal (for example, steel, aluminum), a polymer or plastic, and/or carbon steel. Further, bead body 318 can be made in any suitable manner.

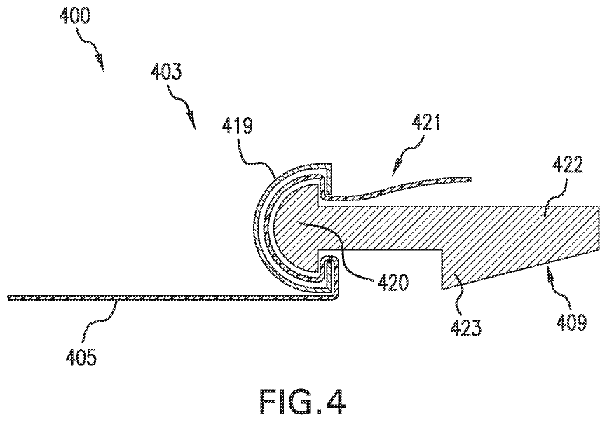

Referring now to FIG. 4, there is shown a side, cross-sectional view of another embodiment of the aquaculture tank system of the present invention. Prior reference numbers with respect to system 100 are increased by a multiple of 100 and are substantially similar to the structures and function described and shown with respect to FIGS. 1-3, unless otherwise shown and/or described differently. Thus, system 100 is now labeled as 400, in FIG. 4. System 400 includes cover 403 which includes netting 405 and perimeter bead assembly 421 coupled with netting 405, perimeter bead assembly 421 including perimeter bead body 409, and retainer mechanism 419. Perimeter bead body 409, which can be formed as a continuous extrusion, includes a radial inner end 420 and a radial outer end 422. Radial inner end 420 forms a continuous bulb 420, and radial outer end 422 includes a continuous bead 423. Retainer mechanism 419 (which can also be referred to as a clip 419) can be made of any suitable material, such as a metal for example, steel, aluminum), a polymer or plastic, and/or carbon steel, and can be made in any suitable manner, such as extrusion. For example, clip 419 can be semi-rigid and resilient and be an extruded plastic, formed separate from perimeter bead body 409. During assembly, a perimeter portion of netting 405 can be wrapped about bulb 420. Then, bulb 420, and the perimeter portion of netting 405, are matingly received by clip 419, netting 405 being partially clamped between clip 419 and bulb 420. In this way, clip 419 can be snapped over both netting 405 and bulb 420 and can extend around the entire perimeter of netting 405 and the entire perimeter extent of bulb 420. Further, although body 409, netting 405, and clip 419 are shown spaced apart and thus loosely fitting relative to one another, it can be appreciated that this is for illustrative purposes and that these structures can fit snugly together.

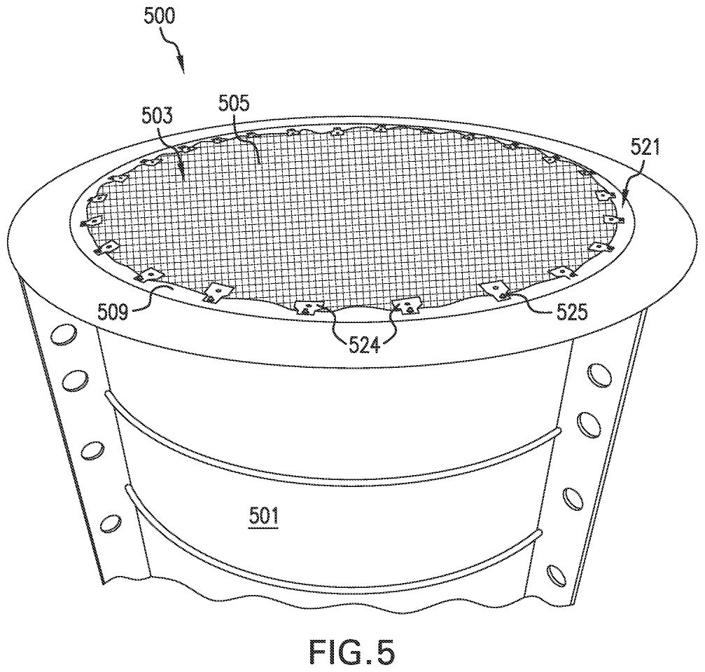

Referring now to FIGS. 5-7, there is shown yet another embodiment of the aquaculture tank system of the present invention. Prior reference numbers with respect to systems 100 and 400 are increased by a multiple of 100 and are substantially similar to the structures and function described and shown with respect to FIGS. 1-4, unless otherwise shown and/or described differently. Thus, system 100 is now labeled as 500, in FIGS. 5-7.

Referring now to FIG. 5, there is shown a perspective view of system 500, with system 500 in FIG. 5 being scaled-down in size relative to system 100 in FIG. 1. System 500 includes aquaculture tank 501 and cover 503 coupled with tank 501. Cover 503 includes netting 505 and perimeter bead assembly 521 coupled with netting 505, perimeter bead assembly 521 including perimeter bead body 509 (which can be formed as a continuous extrusion), a plurality of retainer mechanisms 524, and a plurality of fasteners 525. As seen in FIG. 5, perimeter bead assembly 521 couples netting 505 with tank 501 and extends all around the perimeter of netting 505 and thus also an inner radial perimeter of tank 501. Further, retainer mechanisms 524 are spaced apart a predetermined distance, which can be any suitable distance; by way of example and not limitation, retainer mechanisms 524 can be spaced apart six inches from one another all the way around netting 505. As above, perimeter bead body 509 is continuous all the way around netting 505.

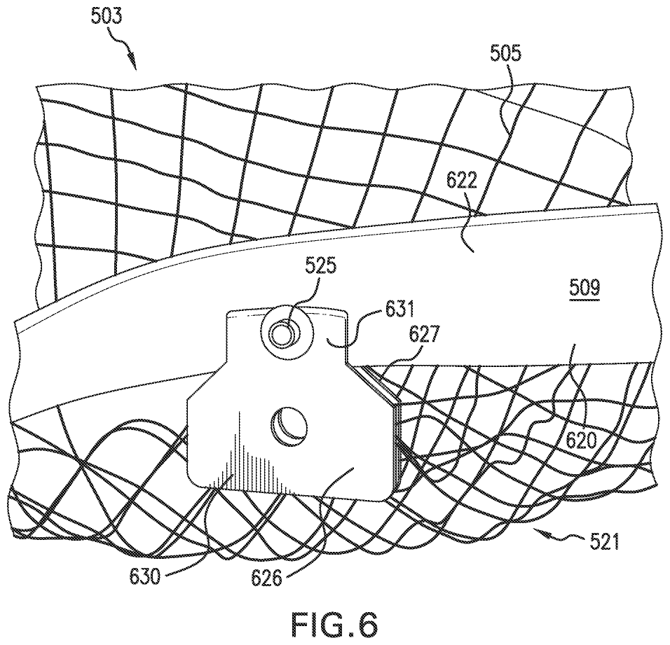

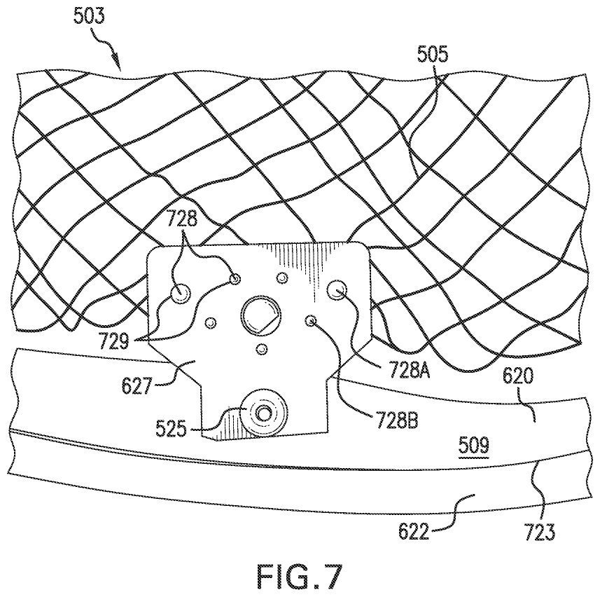

Referring now to FIG. 6, there is shown a perspective view of cover 503, viewing one side of cover 503. Cover 503 includes netting 505 and perimeter bead assembly 521 coupled with netting 505. Perimeter bead body 509 includes radial outer end 622 and radial inner end 620. A respective retainer mechanism 524 is coupled with radial inner end 620 by way of a respective fastener 525, which can be any suitable fastener, such as a bolt and nut combination, a rivet, or the like. Retainer mechanism 524 includes a first end 630 and a second end 631, first end 630 being attached to netting 505, second end 631 being attached to perimeter bead body 509. Retainer mechanism 524, according to one embodiment, can include a first wall 626 and a second wall 627 which are joined to one another, such as by way of a snapping walls 626, 627 together, and by way of fastener 525, wherein fastener 525 can proceed through accommodating holes in each of walls 626, 627 and a hole in perimeter bead body 509 so as to secure walls 626, 627 with perimeter bead body 509. Walls 626, 627 can be snapped together by way of a plurality of protrusions 728 of first wall 626 being inserted into mating holes 729 of second wall 627 (FIG. 7). During assembly of cover 505, netting 505 is placed between first and second walls 626, 627 before walls 626, 627 are snapped together; after doing so, walls 626, 627 can be snapped together so as to sandwich netting 505 between walls 626, 627 and thereby clamp and capture netting 505 therebetween, with protrusions 728 further preventing netting 505 from slipping out from between walls 626, 627. Walls 626, 627 can be made of any suitable material, such as a metal or a polymer or plastic (such as ultraviolet-resistant polypropylene), and can be made in any suitable manner, such as a casting or molding process.

Referring now to FIG. 7, there is shown a perspective view of cover 503, viewing the opposite side of cover 503 relative to FIG. 6. Cover 503 includes netting 505 and perimeter bead assembly 521 coupled with netting 505. Radial outer end 622 includes continuous bead 723, which is received in upper bead slot 316. First wall 626 includes protrusions 728 which protrude from an inner surface of first wall 626, protrusions 728 including large protrusions 728A and small protrusions 728B. Second wall 627 includes holes 729 which matingly receive protrusions 728 therein so as to snap walls 626, 627 together, in any suitable manner, such as by way of a friction fit, and/or an interference fit between protrusions 728 and holes 729. Though two large protrusions 728A and five small protrusions 728B, and thus also large diameter holes 729 and small diameter holes 729, are shown in FIG. 7, it can be appreciated that more or less numbers of such protrusions 728 and holes 729 can be employed, in accordance with the presence invention.

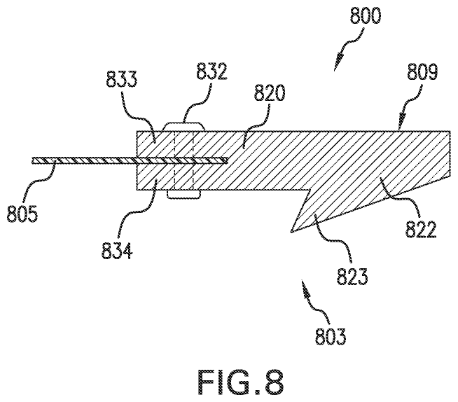

Referring now to FIG. 8, there is shown yet another embodiment of the aquaculture tank system of the present invention. Prior reference numbers with respect to systems 100 and 400 are increased by a multiple of 100 and are substantially similar to the structures and function described and shown with respect to FIGS. 1-4, unless otherwise shown and/or described differently. Thus, system 100 is now labeled as 800, in FIG. 8. In FIG. 8, there is shown a side, cross-sectional view of system 800, similar to FIGS. 3 and 4. System 800 includes cover 803, which includes netting 805, perimeter bead body 805 (which can be formed as a continuous extrusion), and a plurality of fasteners 832, perimeter bead body 805 being coupled with netting by way of fasteners 832, which can be spaced apart a predetermined distance all around the perimeter of cover 805, which can be any suitable distance (for example, and not by way of limitation, six inches). Perimeter bead body includes a radial inner end 820 and a radial outer end 822, radial outer end 822 including continuous bead 823. Radial end 820 includes an upper layer 833 and a bottom layer 834, wherein netting 805 is partially positioned between upper and bottom layers 833, 834 and are coupled with layers 833, 834 by way of fastener 832 (which can be any suitable fastener, such as a bolt and nut combination, a rivet, or the like) extending through upper layer 833, netting 805, and bottom layer 834. To form layers 833, 834, radial inner end 820 can be cut or otherwise split. To assemble cover 803, radial inner end 820 can be split, an outer perimeter of netting 805 can be positioned between layers 833, 834, and fasteners 832 can fasten layers 833, 834 and netting 805 together.

In use, a user can assemble tank 101, 501, installing wall panels 310 in end-to-end fashion, and attaching coupling mechanisms 311 to the upper portion of wall panels 310. Liner bead body 318 can be inserted into lower bead slot 316, securing liner bead body 318 thereto. Before or after filling tank 101, 501 with liquid 104 and/or animals 107, bead 323, 423, 623, 823 of perimeter bead body 209, 409, 509, 809 of cover 103, 403, 503, 803 can be inserted into upper bead slot 315, securing perimeter bead body 209, 409, 509, 809 thereto (all around the upper portion of tank 101, 501. Further, bead 323, 423, 623, 823 of perimeter bead body 209, 409, 509, 809 can be removed from upper bead slot 315. This removal can be total or partial; that is, perimeter bead body 209, 409, 509, 809 can be removed from upper bead slot 315 all around tank 101, 501 such that cover 103, 403, 503, 803 is entirely disengaged from tank 101, 501, or perimeter bead body 209, 409, 509, 809 can be removed from upper bead slot 315 in only a portion, or a plurality of portions, of tank 101, 501 such that cover 103, 403, 503, 803 is disengaged from tank 101, 501 in a certain part(s) of tank 101, 501 while remaining engaged with tank 101, 501 in other parts of tank 101, 501. Thus, such a cover 103, 403, 503, 803 with perimeter bead body 209, 409, 509, 809 affords a simple and quick on/off solution relative to tank 101, 501, as well as a partial off solution, if a user needs to access tank 101, 501; that is, such a beaded cover 103, 403, 503, 803 is an easy on-easy off solution, thus allowing for a partial or total removal of cover 103, 403, 503, 803 in a short time frame. Similarly, liner bead body 318 can be removed from lower bead slot 315 (most likely after removing liquid 104 from tank 101, 501) all around, or only partially around, tank 101, 501.

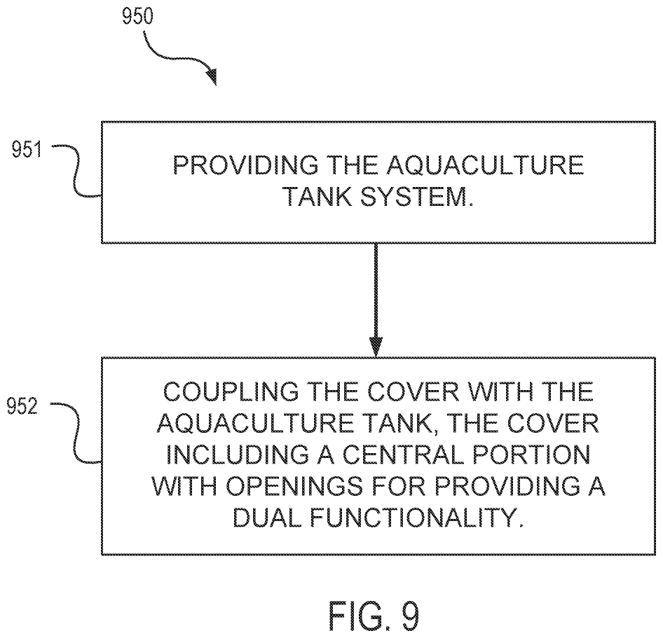

Referring now to FIG. 9, there is shown a flow diagram showing a method 950 of using aquaculture tank system 100, 400, 500, 800. Method 950 includes the steps of: providing 951 that aquaculture tank system 100, 400, 500, 800 includes aquaculture tank 101, 501 and cover 103, 403, 503, 803, aquaculture tank 101, 501 being configured for holding liquid 104 and at least one first animal 107 therein; and coupling 952 cover 103, 403, 503, 803 with aquaculture tank 101, 501 for covering liquid 104, cover 103, 403, 503, 803 including sheet-like central portion 205, 405, 505, 805 with a plurality of openings 206, at least some of openings 206 being sized and configured for providing a dual functionality of: (a) allowing an animal feed to pass therethrough in order to feed the at least one first animal 107 in aquaculture tank 101, 501; and (b) preventing at least one second animal located exterior to aquaculture tank 101, 501 from removing the at least one first animal 107 from aquaculture tank 101, 501. Aquaculture tank 101, 501 includes an upper perimeter 314 and a first bead slot 315 extending at least substantially around the upper perimeter 314, and cover 103, 403, 503, 803 includes a perimeter bead body 209, 409, 509, 809 received within the first bead slot 315. Perimeter bead body 209, 409, 509, 809 is removably received within the first bead slot 315. Perimeter bead body 209, 409, 509, 809 is continuous. Central portion 205, 405, 505, 805 includes a grid-like configuration. Aquaculture tank 101, 501 includes a second bead slot 316, and the aquaculture tank system 100, 400, 500, 800 further includes a tank liner 313 that includes a bead body 318 which is received within the second bead slot 316.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An aquaculture tank system, comprising:
an aquaculture tank configured for holding a liquid and at least one first animal therein; and
a cover coupled with the aquaculture tank for covering the liquid, the cover including a sheet-like central portion with a plurality of openings, at least some of the openings being sized and configured for providing a dual functionality of: (a) allowing an animal feed to pass therethrough in order to feed the at least one first animal in the aquaculture tank; and (b) preventing at least one second animal located exterior to the aquaculture tank from removing the at least one first animal from the aquaculture tank.

2. The aquaculture tank system of claim 1, wherein the aquaculture tank includes an upper perimeter and a first bead slot extending at least substantially around the upper perimeter, and the cover includes a perimeter bead body received within the first bead slot.

3. The aquaculture tank system of claim 2, wherein the perimeter bead body is removably received within the first bead slot.

4. The aquaculture tank system of claim 3, wherein the perimeter bead body is continuous.

5. The aquaculture tank system of claim 3, wherein the central portion includes a grid-like configuration.

6. The aquaculture tank system of claim 2, wherein the aquaculture tank includes a second bead slot, and the aquaculture tank system further includes a tank liner that includes a bead body which is received within the second bead slot.

7. The aquaculture tank system of claim 2, wherein the cover includes a first retainer mechanism, the perimeter bead body including an end matingly received by the retainer mechanism, the central portion being partially clamped between the retainer mechanism and the end.

8. The aquaculture tank system of claim 2, wherein the cover includes a plurality of second retainer mechanisms each of which includes a first end and a second end, the first end being attached to the central portion, the second end being attached to the perimeter bead body.

9. The aquaculture tank system of claim 2, wherein the perimeter bead body includes an end including an upper layer and a bottom layer, the central portion being partially positioned between the upper layer and the bottom layer and being coupled therewith.

10. A cover for use with an aquaculture tank having an upper perimeter with at least one bead slot, the cover comprising:
a sheet-like central portion with a plurality of openings, at least some of the openings being sized and configured for providing a dual functionality of: (a) allowing an animal feed to pass therethrough in order to feed the at least one first animal in the aquaculture tank; and (b) preventing at least one second animal located exterior to the aquaculture tank from removing the at least one first animal from the aquaculture tank; and
a perimeter bead body coupled with the central portion and configured for being received within the at least one bead slot.

11. The cover of claim 10, wherein the perimeter bead body is removably received within the at least one bead slot.

12. The cover of claim 11, wherein the perimeter bead body is continuous.

13. The cover of claim 11, wherein the central portion includes a grid-like configuration.

14. A method of using an aquaculture tank system, the method comprising the steps of:
providing that the aquaculture tank system includes an aquaculture tank and a cover, the aquaculture tank being configured for holding a liquid and at least one first animal therein; and
coupling the cover with the aquaculture tank for covering the liquid, the cover including a sheet-like central portion with a plurality of openings, at least some of the openings being sized and configured for providing a dual functionality of: (a) allowing an animal feed to pass therethrough in order to feed the at least one first animal in the aquaculture tank; and (b) preventing at least one second animal located exterior to the aquaculture tank from removing the at least one first animal from the aquaculture tank.

15. The method of claim 14, wherein the aquaculture tank includes an upper perimeter and a first bead slot extending at least substantially around the upper perimeter, and the cover includes a perimeter bead body received within the first bead slot.

16. The method of claim 15, wherein the perimeter bead body is removably received within the first bead slot.

17. The method of claim 16, wherein the perimeter bead body is continuous.

18. The method of claim 16, wherein the central portion includes a grid-like configuration.

19. The method of claim 15, wherein the aquaculture tank includes a second bead slot, and the aquaculture tank system further includes a tank liner that includes a bead body which is received within the second bead slot.
